(19) United States
(12) Patent Application Publication
(10) Pub. No.: US 2019/0266359 A1
(43) Pub. Date: Aug. 29, 2019

(54) SECURITY SYSTEM AND TERMINAL CHIP

(71) Applicant: HUAWEI TECHNOLOGIES CO., LTD., Shenzhen (CN)

(72) Inventors: Dechao LI, Shenzhen (CN); Yu LIU, Shanghai (CN); Haofeng WANG, Xi' an (CN)

(21) Appl. No.: 16/412,145

(22) Filed: May 14, 2019

Related U.S. Application Data
(63) Continuation of application No. PCT/CN2017/111138, filed on Nov. 15, 2017.

(30) Foreign Application Priority Data
Nov. 15, 2016 (CN) 201611005512.2

(51) Int. Cl. G06F 21/75; G06F 1/08; H04L 9/00

(52) U.S. Cl. CPC G06F 21/755; H04L 9/003; G06F 1/08

(57) ABSTRACT

The disclosure describes a security system, including a security element and a clock randomization processing unit. The clock randomization processing unit is configured to: receive a clock signal, randomly change arrangement of high-level steps or low-level steps in the clock signal, and provide a changed clock signal to the security element. The security system in an embodiment of the present invention first performs randomization processing on the clock signal before inputting the clock signal to the security element, and then inputs a randomized clock signal to the security element. The randomized clock signal causes a module inside the security element to work irregularly. Therefore, it is much more difficult to perform analysis in a side-channel attack, and a security capability of the security element is improved.

### CROSS-REFERENCE TO RELATED APPLICATIONS

This application is a continuation of International Application No. PCT/CN2017/111138, filed on Nov. 15, 2017, which claims priority to Chinese Patent Application No. 201611005512.2, filed on Nov. 15, 2016, The disclosures of the aforementioned applications are herein incorporated by reference in their entireties.

### TECHNICAL FIELD

Embodiments of the present invention relate to the chip field, and in particular, to a security system configured to prevent a side-channel attack, and a terminal chip using the security system.

### BACKGROUND

With performance improvement of intelligent terminals and popularity of Internet applications, people usually use a wireless network of an intelligent terminal to perform online payment or another financial activity in daily life. To reduce accompanying financial security risks, the intelligent terminal is generally provided with a security element. The security element generally includes an in-built coprocessor, security application for encryption, decryption, and authentication, and corresponding protocol platform. The security element provides identity authentication and information encryption services for an intelligent terminal user during a financial transaction process.

Currently, there is a side-channel attack form: injecting information into the security element, observing a reaction of each part in the security element, and determining sensitive information such as an encryption key by means of power consumption analysis, so as to achieve an objective of stealing sensitive information from a security chip.

Therefore, it is necessary to provide a security system to prevent a power consumption analysis attack.

### SUMMARY

An embodiment of the present invention provides a security system. The security system includes a security element and a clock randomization processing unit, where the clock randomization processing unit is configured to: receive a clock signal, randomly change arrangement of high-level steps or low-level steps in the clock signal, and provide a changed clock signal to the security element.

The security system in this embodiment of the present invention first performs randomization processing on the clock signal before inputting the clock signal to the security element, and then inputs a randomized clock signal to the security element. The randomized clock signal causes a module inside the security element to work irregularly. Therefore, it is much more difficult to perform analysis in a side-channel attack, and a security capability of the security element is improved.

The security element is configured to perform security services such as identity authentication and information encryption.

The security element includes a coprocessor, a security bus, and an authentication module.

The randomization processing unit includes a random gating module, and the random gating module is configured to randomly eliminate the high-level steps or low-level steps in the clock signal.

The random gating module includes a random enabling unit and a gating circuit. The random enabling unit randomly generates an enabling signal, and the gating circuit performs gating on the high-level steps and low-level steps in the clock signal based on the enabling signal.

The random gating module further includes a counting de-gating unit. The counting de-gating unit is configured to ensure, in a counting manner, that a symptom that gating is performed on n consecutive high-level steps or low-level steps does not occur, or that a quantity of gating times within a period is not excessively high. In this way, when the security element works under the control of the randomized clock signal, there is no excessively long task processing delay because there is no long interval between the high-level steps or low-level steps.

The randomization processing unit may further include a random jitter module, and the random jitter module is configured to provide a random delay for rising edges of the high-level steps in the clock signal or falling edges of the low-level steps in the clock signal.

The random delay includes a case of no delay.

The security element is configured to provide encryption, decryption, and authentication services for a security application.

An embodiment of the present invention further provides a terminal chip, and the terminal chip includes a security element and the foregoing security system.

An embodiment of the present invention further provides a security element protection method, including: receiving a clock signal, performing randomization processing on the clock signal, and sending a clock signal on which the randomization processing has been performed to a security element. After the randomization processing, arrangement of high-level steps or low-level steps in the clock signal is randomly changed.

The randomization processing includes: randomly eliminating the high-level steps or low-level steps in the clock signal.

The randomization processing may further include: randomly eliminating the high-level steps or low-level steps in the clock signal.

### BRIEF DESCRIPTION OF DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic diagram of a terminal device according to an embodiment of the present invention;

FIG. 2 is a change view of a clock signal under randomization processing according to an embodiment of the present invention;

FIG. 3 is a schematic diagram of a random gating module according to an embodiment of the present invention;

FIG. 4 shows an example of a logic circuit of a random gating module according to an embodiment of the present invention;

FIG. 5 shows an example of a logic circuit of a random jitter module according to an embodiment of the present invention;

FIG. 6 is a schematic diagram of a random gating module according to another embodiment of the present invention; and

FIG. 7 is a schematic diagram of a security element protection method according to an embodiment of the present invention.

### DESCRIPTION OF EMBODIMENTS

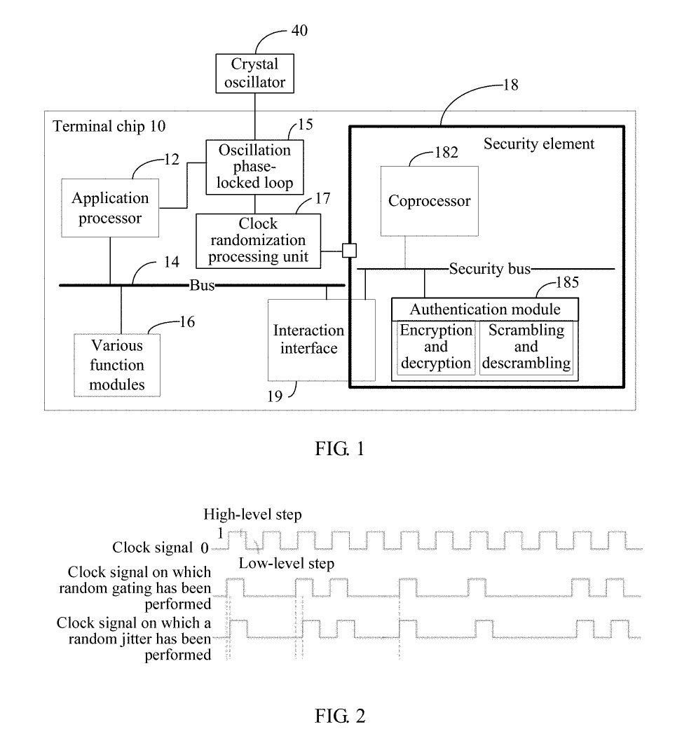

As shown in FIG. 1, a terminal device in an embodiment of the present invention includes a terminal chip 10. Function modules in the terminal chip 10 include an application processor 12, a bus 14, an oscillation phase-locked loop 15, various function modules 16, a clock randomization processing unit 17, and a security element 18.

The application processor 12 is a so-called central processing unit (CPU), and is configured to execute tasks in accordance with instructions of various application programs. The application processor 12 interacts with the various function modules 16 in the terminal chip 10 by using the bus 14. The application programs executed by the application processor 12 are divided into two types: One type of common applications without a security requirement or merely with a relatively low security requirement, such as web browsing and media file playing; and the other types of security applications with a security requirement, such as financial payment and identity authentication.

The security element 18 is an embedded independent security system, and the security element 18 includes a coprocessor 182 configured to perform calculation and an authentication module 185 configured to perform security authentication.

When the application processor 12 executes a security application, the security application needs to use the authentication module 185 in the security element 18 to perform security authentication. The application processor 12 may send a request to the security element 18 by using an interaction interface 19. The interaction interface 19 may be a shared cache that can be accessed by both the application processor 12 and the coprocessor 182.

Working pace of an integrated circuit is controlled by a clock signal. The terminal device further includes a crystal oscillator 40. The crystal oscillator 40 is used as a clock source of the terminal chip 10, and sends a clock signal to the terminal chip 10.

The terminal chip 10 includes the oscillation phase-locked loop 15. The oscillation phase-locked loop 15 is configured to receive the clock signal sent by the crystal oscillator 40, and perform processing (such as frequency multiplication) on the clock signal according to a requirement of each module in the terminal chip, and a processed clock signal is sent to each module in the terminal chip 10.

To improve security performance of the security element under a power consumption analysis attack, the terminal chip 10 in this embodiment of the present invention further includes the clock randomization processing unit 17. The clock randomization processing unit is configured to first perform randomization processing on the clock signal sent by the oscillation phase-locked loop 15 to the security element 18, and then provide a clock signal on which the randomization processing has been performed to the security element 18, to use the processed clock signal as a working clock of each module in the security element 18. In this embodiment of the present invention, randomization processing is performed on the clock signal to eliminate periodicity of the clock signal of the security element 18, so as to greatly improve power consumption analysis difficulty, and prevent an attacker from stealing sensitive information from the security element by means of a side-channel attack such as power consumption analysis.

Generally, a clock signal output from the oscillation phase-locked loop 15 in the terminal chip is a rectangular square wave including two levels: 1 (a high level) and 0 (a low level). In another perspective, it may also be considered that the clock signal includes consecutive high-level steps or low-level steps, for example, a clock signal shown in FIG. 2. The randomization processing can be understood as changing an occurrence rule of the high-level or low-level steps in an input clock signal.

In this embodiment of the present invention, the randomization processing includes random gating and a random jitter.

The random gating is intended to randomly eliminate high-level steps or low-level steps that are supposed to be generated in the clock signal. As shown in FIG. 2, after random gating processing, a second high-level step, a fifth high-level step, a seventh high-level step, a ninth high-level step, and a tenth high-level step that should have been generated in the clock signal are not generated, but are replaced by low-level signals. Certainly, if the random gating processing is intended to eliminate the low-level steps, high-level signals are remained in positions of the eliminated low-level steps.

The random jitter is intended to randomly delay occurrence of a high-level step or a low-level step. As shown in FIG. 2, after the random jitter, occurrence of a first high-level step of the clock-signal on which random gating has been performed is delayed, and a second high-level step occurs after a longer delay. A delay caused by the random jitter is random, and even no delay is caused. For example, as shown in FIG. 2, there is no delay for occurrence of a fourth high-level step in the clock signal on which the random jitter has been performed.

As described above, after the random gating and the random jitter, the input clock of the security element 18 is greatly changed, and original periodicity of the input clock is hidden. This greatly improves a difficulty for performing a side-channel attack such as power consumption analysis. However, in an optional embodiment, performing only one of the random gating or the random jitter can also change a characteristic of the clock signal to a degree, thereby affecting power consumption analysis. In addition, the random gating and the random jitter in this embodiment of the present invention are merely examples of randomization processing. To eliminate periodicity of the clock signal, or change an occurrence rule of the high-level steps or the low-level steps, a person skilled in the art should be able to put forward another solution based on an idea of the present invention. For example, a rule merely known to a chip or terminal vendor is used to perform gating or a jitter on the high-level steps or low-level steps in the clock signal, and other people cannot learn about the rule without analysis. This is actually performing randomization processing on the clock signal.

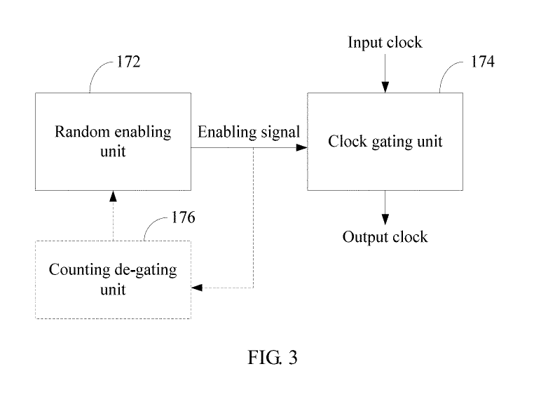

FIG. 3 is a schematic diagram of a random gating module according to an embodiment of the present invention. The random gating module includes a random enabling unit 172 and a clock gating unit 174.

The random enabling unit 172 is configured to randomly generate an enabling signal, for example, randomly generate 0 or 1. The random enabling unit 172 includes a built-in random number generator. After comparing a value of the random number generator and a specified value, the random enabling unit 172 generates an enabling signal according to a comparison result.

The clock gating unit 174 is configured to receive a clock signal, and perform gating on the clock signal based on the enabling signal output from the random enabling unit 172. A gating circuit is a basic circuit device in an integrated circuit, and a working principle of the gating circuit is not described in detail in this embodiment of the present invention.

In an optional embodiment, the random gating module further includes a counting de-gating unit 176. The counting de-gating unit 176 is configured to ensure, in a counting manner, that a symptom that gating is performed on n consecutive high-level steps or low-level steps does not occur, or that a quantity of gating times within a period is not excessively high, where n is a preset value, and may be set according to a response timeout that is set when an application processor accesses a security element by using the security application.

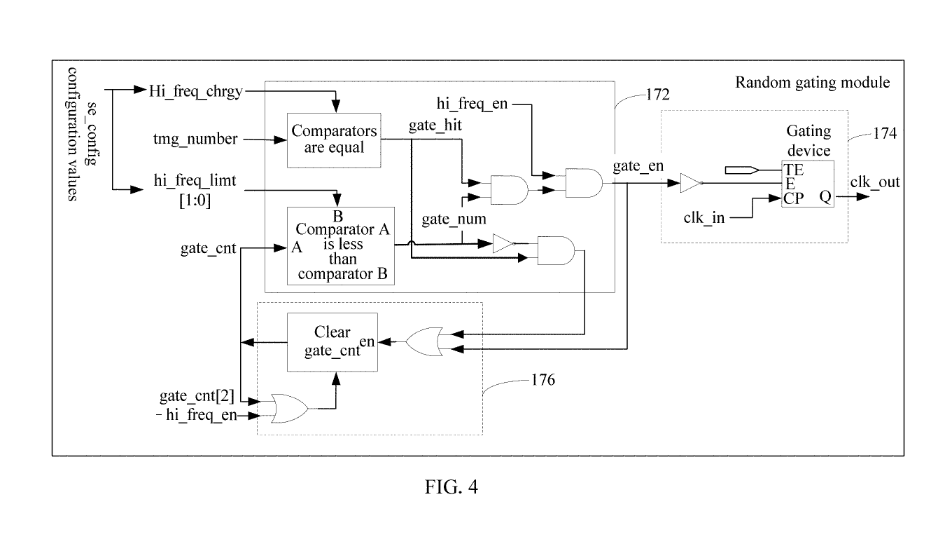

FIG. 4 shows an example of a logic circuit of a random gating module according to an optional embodiment of the present invention. trng_numb is a random number (generated by the random number generator), and only 1 bit is used as a random source; hi_freq_chrgy, hi_freq_limt[1:0], and hi_freq_en (−hi_freq_en is a negated hi_freq_en) are configuration values of a register. The random gating module uses a random number (trng_numb) generated by trng to perform random control. When the random number is the same as the configuration value (hi_freq_chrgy), a gate_hit value is set to 1; or when the random number and the configuration value (hi_freq_chrgy) are different, the value is set to 0. A hit probability of a random number 1 bit is ½. When the configuration value hi_freq_limt[1:0] is compared with a gate_cnt value, if a configuration requirement (that is, gate_cnt is less than the configuration value hi_freq_limt[1:0]) is met, a gate_num value is set to 1; otherwise, the value is set to 0. When both gate_hit and gate_num are 1, gate_en is set to be an enable signal, and a gating device performs gating; and when gate_hit is 1 and gate_num is not 1, it indicates that a quantity of gating times reaches a preset maximum value in this round, and no gating can be performed, but an operation of adding 1 to the gate_cnt is performed. When the gate_cnt value is 4 (that is, gate_cnt[2] is 1), the gate_cnt value is cleared to reset a counter. hi_freq_en may also be used to control enablement and disablement of a random gating function.

The logic circuit of the random gating module in FIG. 4 is merely for reference. To implement functions of modules in FIG. 3, a person skilled in the art should be able to find design manners of multiple logic circuits in light of this embodiment of the present invention. Therefore, the logic circuit in FIG. 4 should not be construed as a limitation on implementation of the present invention.

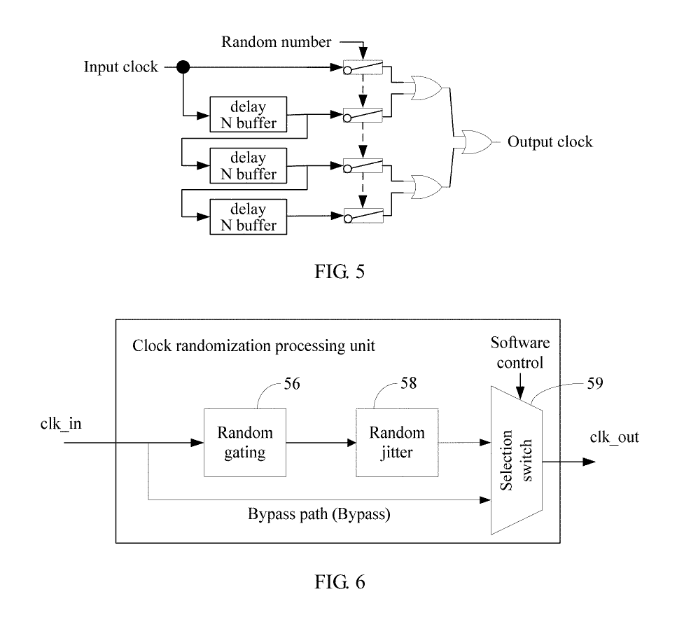

As described above, a random jitter module is configured to provide a random delay for rising edges of high-level steps or falling edges of low-level steps. This can be implemented by using a delay circuit selected from a plurality of delay circuits. FIG. 5 shows an example of a random jitter module according to an embodiment of the present invention. As shown in the figure, the random jitter module uses a random number generator to generate a random number, and generates a gating signal of four bits by means of one hot encoding (one hot). Only one bit of the gating signal of four bits is 1, and other bits are 0. By inserting a delay buffer and the gating signal, it is equivalent to a fact that the logic circuit shown in FIG. 5 is divided into four clock paths, and the four clock paths include 0, N, 2N, and 3N delay buffers respectively to provide a delay. In this way, if a high-level signal in the clock signal in the random jitter module passes through a random path, a delay effect of 0, N, 2N, or 3N delay buffers can be achieved. Provided that the random number generated by the random number generator matches an occurrence time of high-level signals or low-level signals in the clock signal, the random jitter module shown in FIG. 5 can provide an accurate delay for each high-level step or low-level step. To match the random number generated by the random number generator with an occurrence time of the high-level signals or low-level signals in the clock signal, a feasible manner is to generate a random number in accordance with an original clock period. The random gating module merely eliminates steps, but does not change an occurrence time of remaining steps. Therefore, the random number generator can generate a random number completely according to the clock signal that does not enter the random gating module yet.

A random jitter circuit in FIG. 5 is also merely an example. To implement a random jitter function, a person skilled in the art should be able to find a plurality of logical implementations in light of this embodiment of the present invention. Therefore, the logic circuit in FIG. 5 should not be construed as a limitation on implementation of the present invention.

FIG. 6 is a schematic diagram of a randomization processing module according to another optional embodiment of the present invention. As shown in the figure, the randomization processing module in this embodiment of the present invention includes the foregoing random gating module 56 and random jitter module 58. The randomization processing module further includes a selection switch 59, so that an input clock of the clock randomization processing unit is directly sent to a security element through a bypass path without passing through the random gating module 56 and the random jitter module 58. The bypass path is designed in this embodiment of the present invention, so that a normal clock can be immediately input into the security element when required, to meet a requirement in cases of a test, a system error, or the like.

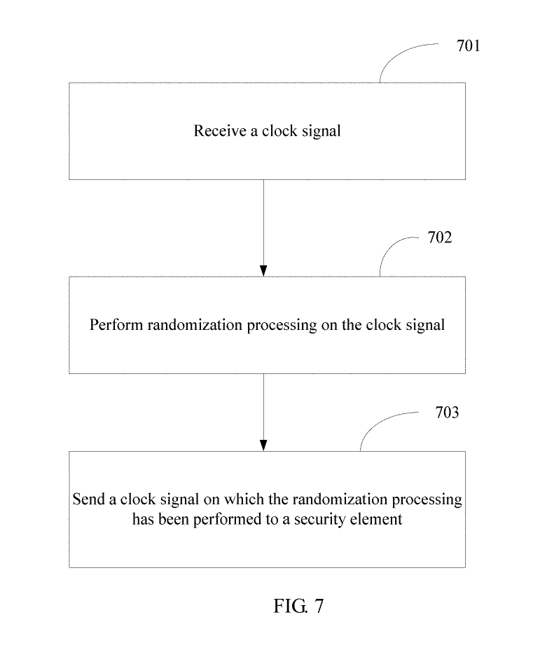

FIG. 7 is a flowchart of a security element protection method according to an embodiment of the present invention. The security element protection method provided in this embodiment of the present invention includes the following operations.

In operation 701, a clock signal is received.

In operation 702, randomization processing is performed on the clock signal.

In operation 703, a clock signal on which the randomization processing has been performed is sent to a security element.

For details about randomization processing mentioned in this embodiment of the present invention, refer to the foregoing embodiments.

In the embodiments provided in this application, it should be understood that the disclosed system may be implemented in another manner. For example, the described apparatus embodiment is merely an example. For example, the module division is merely logical function division and may be another division in actual implementation. For example, multiple units or elements may be combined or may be integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The modules described as separate parts may or may not be physically separate, and parts displayed as modules may or may not be physical units, may be located in one position, or may be distributed on a plurality of network nodes. Some or all of the nodes may be selected according to actual needs to achieve the objectives of the solutions of the embodiments.

In addition, function modules in the embodiments of the present invention may be integrated into one physical unit, or each of the modules may exist alone physically, or two or more modules are integrated into one unit. The integrated unit may be implemented in a form of hardware, or may be implemented in a form of a software functional unit.

The foregoing embodiments are merely intended for describing the technical solutions of the present invention, but not for limiting the present invention. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. A security system, comprising:
a security element; and
a clock randomization processing unit
configured to:
receive a clock signal,
randomly change arrangement of high-level steps or low-level steps in the clock signal, and
provide a changed clock signal to the security element.

2. The security system according to claim 1, wherein the clock randomization processing unit comprises a random gating module, and the random gating module is configured to randomly eliminate the high-level steps or low-level steps in the clock signal.

3. The security system according to claim 2,
wherein the random gating module comprises a random enabling unit and a gating circuit, wherein the random enabling unit is configured to randomly generate an enabling signal, and wherein the gating circuit is configured to perform gating on the high-level steps and low-level steps in the clock signal based on the enabling signal.

4. The security system according to claim 3, wherein the random gating module further comprises a counting de-gating unit, and wherein the counting de-gating unit is configured to ensure, in a counting manner, that a symptom that gating is performed on n consecutive high-level steps or low-level steps does not occur, or that a quantity of gating times within a period is not excessively high.

5. The security system according to claim 1, wherein the clock randomization processing unit comprises a random jitter module, and wherein the random jitter module is configured to provide a random delay for rising edges of the high-level steps in the clock signal or falling edges of the low-level steps in the clock signal.

6. A terminal chip, comprising the security system according to claim 1.

7. The terminal chip according to claim 6, wherein the terminal chip further comprises an oscillation phase-locked loop, and wherein the oscillation phase-locked loop is configured to receive a clock source signal outside the terminal chip, and process the clock source signal to obtain the clock signal, and the clock signal is sent to the clock randomization processing unit.

8. A security element protection method, comprising:
receiving a clock signal;
performing randomization processing on the clock signal, wherein after the randomization processing, arrangement of high-level steps or low-level steps in the clock signal is randomly changed; and
sending a clock signal on which the randomization processing has been performed to a security element.

9. The method according to claim 8, wherein the randomization processing comprises:
randomly eliminating the high-level steps or low-level steps in the clock signal.

10. The method according to claim 8, wherein the randomization processing comprises:
providing a random jitter for rising edges of the high-level steps in the clock signal or falling edges of the low-level steps in the clock signal.
